(19) United States
(12) Patent Application Publication
(10) Pub. No.: US 2023/0220724 A1
(43) Pub. Date: Jul. 13, 2023

(54) MODULAR DOOR CHASSIS

(71) Applicant: LEATHERHEAD HOLDINGS, LLC, Brenham, TX (US)

(72) Inventors: Samuel W. Larkin, Brenham, TX (US); Anthony R. Riggens, Magnolia, TX (US)

(73) Assignee: LEATHERHEAD HOLDINGS, LLC, Brenham, TX (US)

(21) Appl. No.: 18/179,581

(22) Filed: Mar. 7, 2023

Related U.S. Application Data
(60) Provisional application No. 63/298,707, filed on Jan. 12, 2022.

(51) Int. Cl. E06B 3/70

(52) U.S. Cl. CPC E06B 3/70; E06B 2003/7074; E06B 2003/7088

(57) ABSTRACT

The present disclosure provides a commercial door chassis that utilizes screw splines instead of prior art shear blocks to connect the chassis rails to the chassis stiles. Each of the door stiles has a small opening near each end on the exterior face of the stile in which the screw splines may be inserted through the stile to couple with an end portion of the adjoining rail, thereby providing a tension joint. A joining plate may be added to the chassis for increased support fastening between the rail and the stile, and may be inserted into the inner portion of the stile as the screws are fastened. In addition, the exterior face of the stile comprises a groove down the length of the exterior face of the stile in which a plurality of different astragals may be positioned to provide an exterior shape of the door chassis as desired.

### PRIORITY

This application claims priority to U.S. provisional patent application No. 63/298,707, filed on Jan. 12, 2022, the entire contents of which is incorporated herein by reference.

### BACKGROUND OF THE INVENTION

### Field of the Invention

The present invention relates to a door chassis, and more particularly to commercial modular aluminum door chassis.

### Description of the Related Art

Conventional commercial metal door chassis or frames are built to order in a commercial factory to customer specifications and shipped to the customer for on-site installation. Existing aluminum doors are expensive and take a long lead time to manufacture.

For the purposes of this disclosure, a commercial door chassis is composed of four pieces: two horizontal pieces (rails) and two vertical pieces (stiles) that are coupled together via a variety of different mechanisms. Many existing door products on the market today use either a shear block or welded clip design, or a combination of the two. For example, FIG. 1A illustrated a welded clip design 101 with clip 111, while FIGS. 1B-1D illustrate a shear block design. Other products may incorporate the use of a tie rod to span the width of the door to provide the necessary strength. The shear block construction method requires a substantial sized aluminum block 113 with screw splines 133 in a vertical orientation to allow rails 111, 115 to attach (see FIGS. 1B and 1C). In many cases, it is only bolted to the stile with a single bolt/washer/nut through the center of the block. Others use a threaded plate to bolt the shear block. The rail is then drilled to match the screw spline in the shear block. These holes need to be precisely off-center as they should attempt to squeeze the rail to the stile. If the holes are not correct it will not draw the rail into the stile enough and leave a small gap in the joint, or it may draw it too much and possibly shear the screw. The screw used to attach the rail to the stile is usually small, with typically two screws 133 on each side of the rail (see FIG. 1D). Because the shear block's screw splines are parallel to the stile, it places these small screws in shear load.

The referenced shortcomings are not intended to be exhaustive, but rather are among many that tend to impair the effectiveness of previously known techniques in seafloor deployment systems; however, those mentioned here are sufficient to demonstrate that the methodologies appearing in the art have not been satisfactory and that a significant need exists for the systems, apparatuses, and techniques described and claimed in this disclosure.

A need exists for an improved door chassis that is readily manufactured, versatile, and can be assembled on site. A need exists for an improved door chassis that is easier to fabricate and assemble, and that will have less field issues and maintenance problems. A need exists for a standardized door chassis design that eliminates the need for a shear block.

### SUMMARY OF THE INVENTION

The present disclosure provides a commercial door chassis that utilizes screw splines instead of prior art shear blocks to connect the chassis rails to the chassis stiles. Each of the door stiles has a small opening near each end on the exterior face of the stile in which the screw splines may be inserted through the stile to couple with an end portion of the adjoining rail, thereby providing a tension joint. A coupling or joining plate may be added to the chassis for increased support fastening between the rail and the stile, and may be inserted into the inner portion of the stile as the screws are fastened. In addition, the exterior face of the stile comprises a groove down the length of the exterior face of the stile in which a plurality of different astragals may be positioned to provide an exterior shape of the door chassis as desired. The disclosed door chassis may be installed on site and requires much less assembly time and required parts. The disclosed door chassis provides a highly customizable and readily manufactured and installable design that is less expensive and stronger than existing chassis products.

Disclosed is a door chassis system that comprises a plurality of rails and a plurality of stiles. The plurality of stiles is coupled to the plurality of rails by a plurality of fasteners, such as screws. Each of the plurality of stiles has an exterior face with a groove that is configured to receive a removable astragal or door cover. The exterior face of the stile may have an opening configured to receive the plurality of fasteners. The door chassis may have a coupling plate configured to attach each of the plurality of rails to each of the plurality of stiles. The coupling plate may be inserted through an opening on an exterior face or an exterior end of the stile. Holes for the fasteners may be located on an interior portion of the stile and corresponding holes may be located on a portion of the rail and the coupling plate, such that the fasteners may be inserted into the plate, through the holes on the stile, and into the holes on the rail to create a secure joint.

Also disclosed is a door chassis joint apparatus that comprises a rail, a stile, a coupling plate, and a plurality of screws that couple the rail to the stile, wherein the coupling plate is located in an interior portion of the stile, and wherein the plurality of screws couple the coupling plate to the stile. The door chassis may comprise a groove in an exterior face of the stile configured to receive a removable astragal.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIGS. 1A-1D illustrate prior art commercial metal door chassis assemblies.

FIG. 2A illustrates a perspective view of a door chassis according to one embodiment of the present disclosure.

FIG. 2B illustrates an enlarged view of the top right rail and right stile from FIG. 2A.

FIGS. 2C-2D illustrate detailed views of the screw spline construction from FIG. 2B.

FIGS. 2E-2G illustrate isometric views of components from FIG. 2C.

FIGS. 3A-3B illustrate embodiments of a vertical stile component and a horizontal rail component, respectively, that can be used with the door chassis of FIG. 2A.

FIGS. 3C-3D illustrate embodiments of removable glass stops for ¼″ glass and 1″ insulated glass, respectively, that can be used with the door chassis of FIG. 2A.

FIGS. 3E-3F illustrate embodiments of profile covers that can be used with the door chassis of FIG. 2A.

FIG. 3G illustrates one embodiment of a butt hinge back-up plate that can be used with the door chassis of FIG. 2A.

FIG. 3H illustrates one embodiment of a screw-splined mid panel that can be used with the door chassis of FIG. 2A.

FIGS. 4A-4C illustrate embodiments of a butt hinge, pivot hinge, and continuous hinge, respectively, that can be used with the door chassis of FIG. 2A.

### DETAILED DESCRIPTION

Various features and advantageous details are explained more fully with reference to the nonlimiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

### Overview

The present disclosure provides a novel fastening technique of a commercial door rail to a stile. In one embodiment, prior art shear blocks are eliminated and replaced with screw splines. Such a design eliminates expensive (and heavy) aluminum shear blocks at each corner of the door chassis, which reduces construction costs, assembly time, and required parts. The integration of the screw into the rail provides other several advantages. For example, the disclosed screw spline places the attachment hardware in tension, which is a stronger joint, and pulls the rail to the stile, providing the same repeatable fit every time. Further, the disclosed joint utilizes the full profile of the rail against the face of the stile as strength and support, not just a few small screws. A plate may be added for increased support fastening between the rail and the stile. In addition, the exterior face of the stile comprises a groove in which a plurality of different astragals may be positioned. The disclosed commercial door chassis provides a highly customizable and readily manufactured and installable design that is less expensive and stronger than existing chassis products.

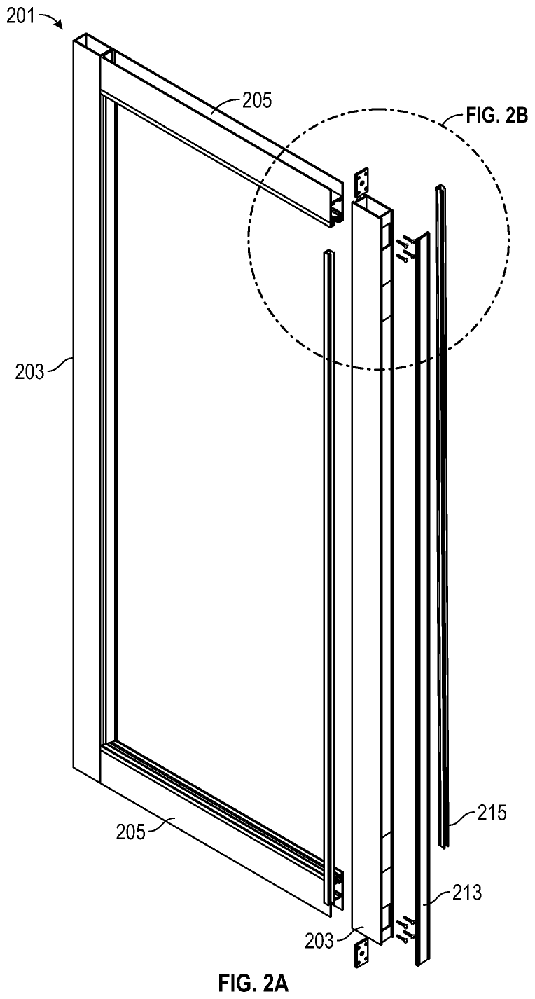

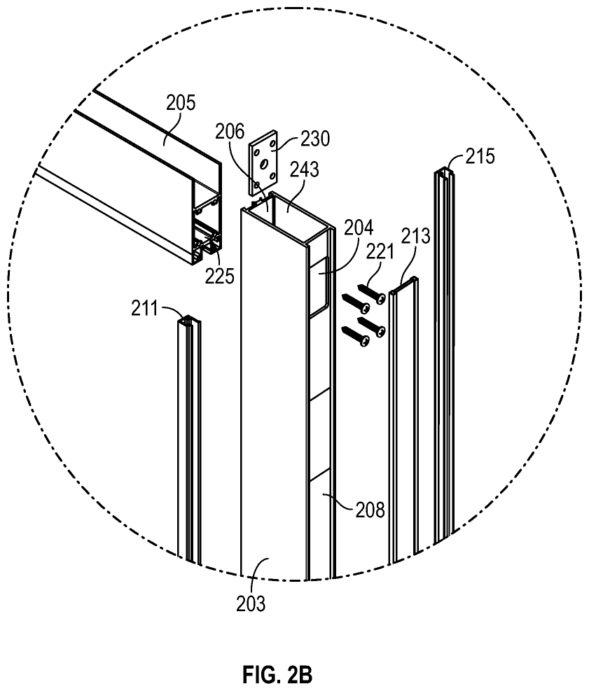

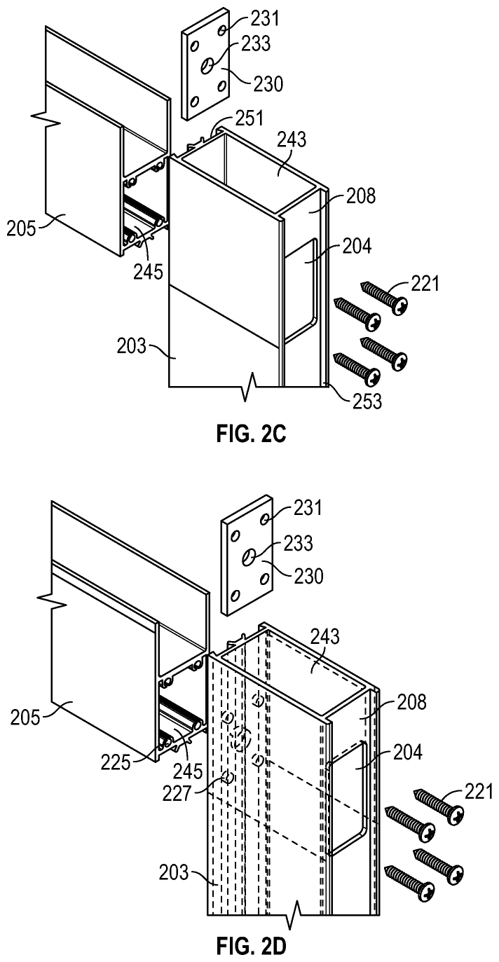

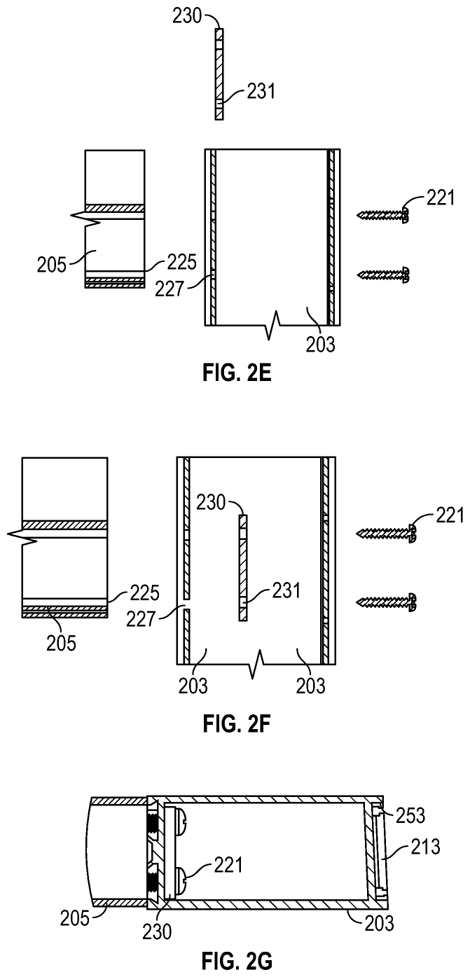

FIG. 2A illustrates a perspective view of a door chassis according to one embodiment of the present disclosure. FIG. 2A illustrates an overall view with an exploded stile to show how the top and bottom rails are held together with screw spline construction. In one embodiment, door chassis 201 comprises two vertical stiles 203 and two horizontal rails 205, which may be hard plastic or metal. In one embodiment, the chassis is made of aluminum. In one embodiment, the door chassis comprises hollow aluminum square (or rectangular) extruded tubing. Each end of stile 203 is fastened to a corresponding end of rail 205, as better seen by enlarged portion illustrated in FIG. 2B. In one embodiment, an end portion of each rail is coupled to a side portion of each stile. Typically, stile 203 is longer than rail 205.

FIG. 2B illustrates an enlarged view of a top portion of the upper rail and right stile from FIG. 2A. As shown in FIG. 2B, stile 203 has an inner face 206 and an outer face 208. Each end of stile 203 has opening 243, through which coupling plate 230 may be inserted. Likewise, an end of rail 205 has opening 245. Near each end of stile 203 comprises an opening 204 on exterior face 208. Opening 204 allows plurality of screws 221 to be inserted into the interior of the stile to screw stile 203 to rail 205 via coupling plate 230. Back-up or coupling plate 230 may be placed inside stile 203 (via opening 243) to provide strength and support for joining the stile and rail. In one embodiment, four screws 221 are utilized and are placed as far part as possible from each other to increase the fastening strength and distribution of forces for the joint. As opposed to prior art fastening techniques for joining a rail to a stile, the disclosed embodiment places the hardware in tension, which pulls the rail to the stile, and the joint utilizes the full profile of the rail against the face of the stile as strength and support. The front and back portions of the stile (e.g., the interior and exterior stile faces 206 and 208) may comprise or be coupled with glass stops 211, 215, as is known in the art. In one embodiment, an inner face of the stile (and rail) may have one or more grooves 251 (see FIG. 2C) that can receive the glass stops. A profile cover or astragral 213 may be inserted into a groove (such as exterior groove 253, see FIG. 2C) on an exterior face of stile 203 to cover any access holes in the stile and to provide weathering as needed. In one embodiment, the exterior face of the stile comprises a groove in which a plurality of different astragals may be positioned to provide different door profiles, thereby eliminating the need for many different shapes of stiles depending on the desired design. In the prior art, the door chassis was molded into different shapes to provide different profiles. The disclosed design allows a single stile shape to be utilized for any number of different astragal shapes or stile profiles. This greatly reduces manufacturing time and costs.

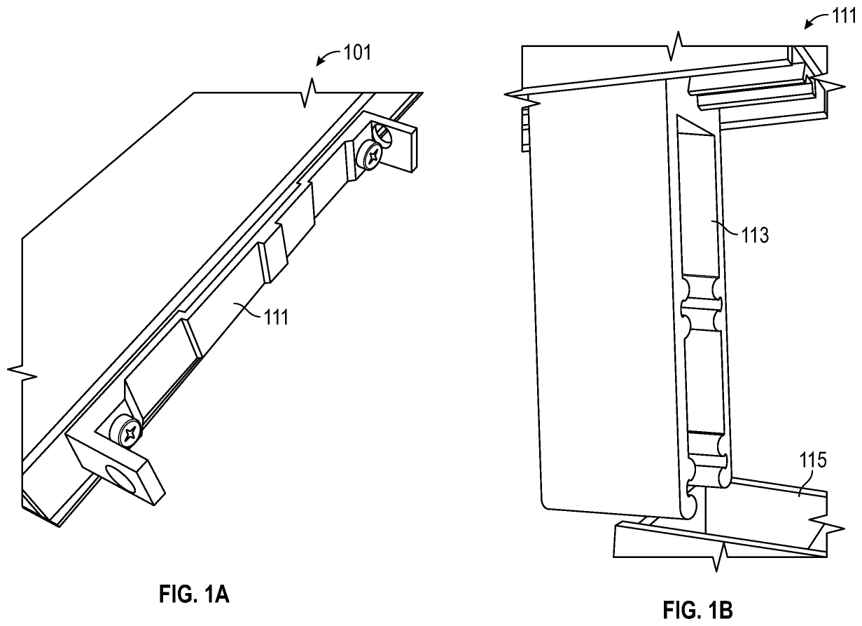

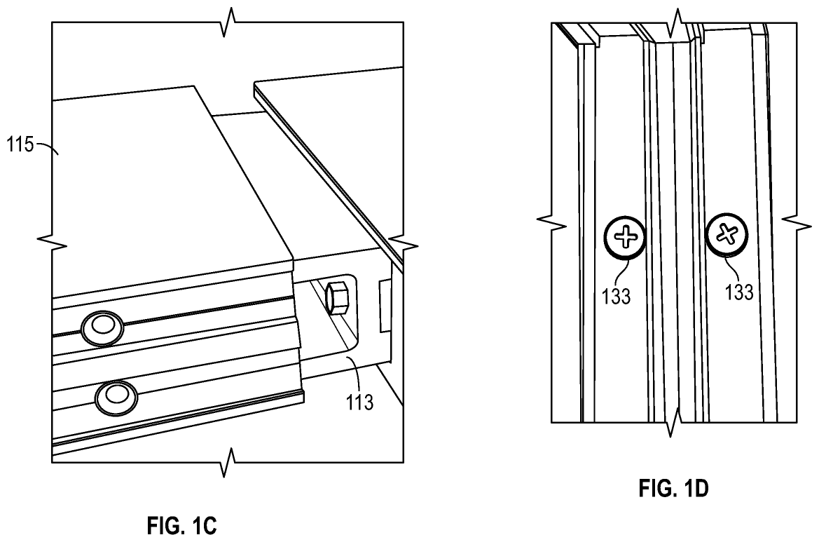

FIGS. 2C-2D illustrate detailed views of the screw spline construction from FIG. 2B and the door chassis from FIG. 2A. FIG. 2C illustrates an exterior perspective view of the stile/rail joint from FIG. 2B, while FIG. 2D illustrates an interior view of the stile of FIG. 2C. Back-up plate 230 may be formed of 3/16″ steel that assists in distributing the forces of the four attachment screws 221. In one embodiment, plate 230 comprises four screw holes 231 arranged near the corners of the plate and a large hole 233 in the center of the plate configured to receive an optional tension rod. As shown in FIG. 2D, an end portion of rail 205 comprises screw holes 225 in opening 245; likewise, an inner face of stile 203 comprises screw holes 227. Holes 225, 227 are aligned with holes 231 on plate 230 such that when the plate is positioned in opening 243 and against the inner face of the stile, all of the screw holes align, and screws 221 can be used to fasten the stile, rail, and coupling plate together. Such a design allows the disclosed door chassis to be assembled much faster, cheaper, and more accurately than a prior art door chassis that uses a traditional shear block construction, as represented in FIGS. 1A-1D. In some embodiments, a tension rod (not illustrated) may be placed inside the stile to provide additional support. Such a tension rod may be pre-installed at the time of manufacture or be installed at a later date, and may comprise a ⅜″ all threaded steel rod with locking nuts to help hold the joints together. The tension rod allows the door chassis to achieve desired specifications in some applications, without welding, while remaining field serviceable. While FIG. 2B illustrates one corner of a door chassis as disclosed in FIG. 2A, one of ordinary skill will realize that each corner of the door chassis may comprise a similar coupling mechanism.

FIGS. 2E-2G illustrate isometric views of components from FIG. 2C. FIGS. 2E and 2F illustrate positions of back-up plate 230 during install from a side cross-sectional view, while FIG. 2G shows back-up plate 230 after installation from a top cross-sectional view. In particular, FIG. 2E shows back-up plate 230 exterior to the stile, FIG. 2F shows back-up plate 230 in an interior portion of the stile prior to joining, and FIG. 2G illustrates an interior portion of the rail and stile joint in which back-up plate 230 is installed with screws 221 connecting stile 203 to rail 205. FIG. 2G also illustrates an exterior face of stile 203 that illustrates groove 253 configured to receive astragal 213. FIGS. 2E and 2F illustrate plate 230 having plate screw holes 231, which align with screw holes 225 of rail 205 and screw holes 227 of stile 203.

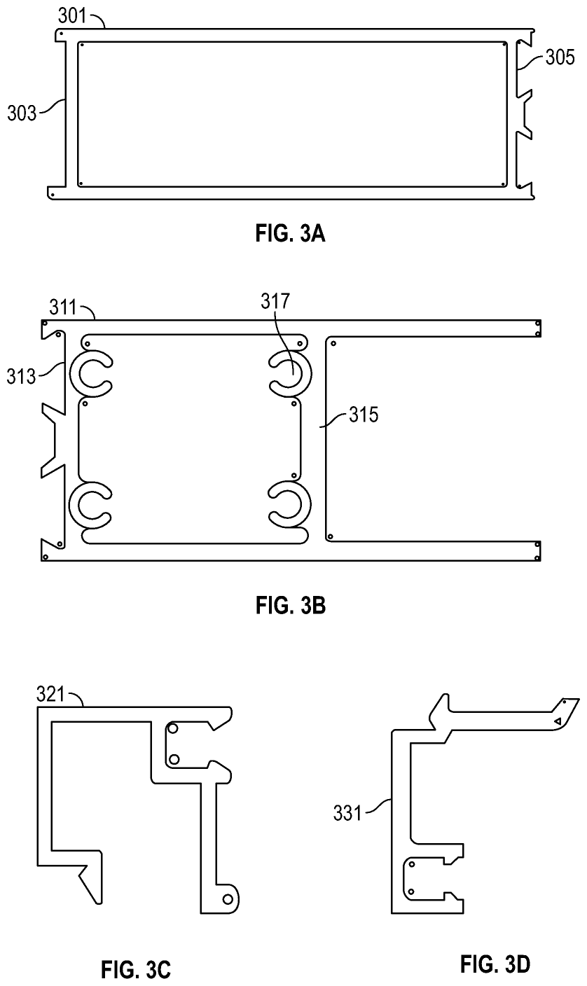

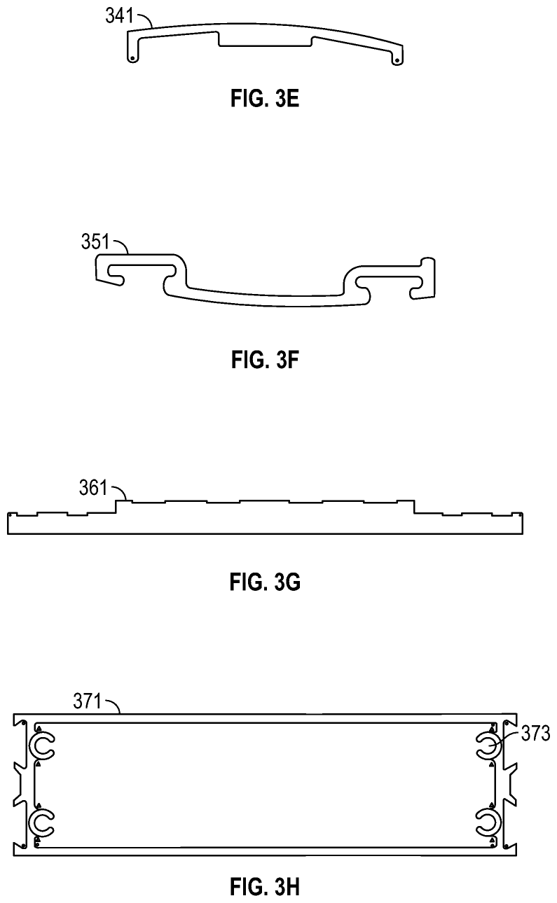

FIGS. 3A-3H illustrate cross-sectional embodiments of various components from the door chassis of FIG. 2A.

FIGS. 3A-3B illustrate embodiments of a vertical stile member and a horizontal rail member, respectively, that can be used with the door chassis of FIG. 2A. FIG. 3A illustrates a cross section of stile 301 for a vertical member (stile). Stile 301 illustrates a wide stile of a door frame, but is representative of a narrow and medium stile, with the only differences being the different widths between the stiles. Outside portion 303 is an outer edge of the door frame, in which a profile cover (such as astragal 213) may be applied after the door chassis is assembled. Inside portion 305 is an inside edge of the door frame which comprises one or more grooves or pockets in which glass stops can be inserted. Inside portion 305 also comprises screw holes (not shown) in which a back-up coupling plate (and optional tie rod) would pass through to attach the stile to the rail (such as in FIG. 3B). FIG. 3B illustrates a cross section of rail 311 for a horizontal member (rail). Stile 311 illustrates a medium stile of a door frame, but is representative of a narrow and wide stile, with the only differences being the different widths between the stiles. Outside portion 313 is an outer edge of the door frame, in which a profile cover/astragal may be applied after the door chassis is assembled. Inside portion 315 is an inside edge of the door frame. In some embodiments, an inside portion 315 may comprise one or more grooves or pockets in which glass stops can be inserted. An end portion of stile 311 comprises a plurality of screw holes 317, in which screw splines can be inserted from the rail into the stile (see FIG. 2B) in addition to a coupling plate, such as back-up plate 230. In one embodiment, screw holes 317 may be substantially similar to screw holes 225 (see FIG. 2D). Inside portion 305 also comprises screw holes (not shown) in which a back-up coupling plate (and optional tie rod) would pass through to attach the stile to the rail (such as in FIG. 3B).

FIGS. 3C-3D illustrate embodiments of removable glass stops 321, 331 for ¼″ glass and 1″ insulated glass, respectively, that can be used with the door chassis of FIG. 2A, shown in a cross-sectional layout. These stops may be inserted into the interior grooves or faces of the rails and stiles of FIG. 2A, and are configured to hold various sizes of glass for the door chassis.

FIGS. 3E-3F illustrate embodiments of profile covers that can be used with the door chassis of FIG. 2A, shown in a cross-sectional layout. FIG. 3E illustrates profile cover 341, which is a smooth bevel profile, while FIG. 3F illustrates profile cover 351, which is a dual-seal type profile better for protection against dirt, dust, wind, and temperatures. These profile covers (or astragals) may be inserted or attached to the exterior grooves or faces of the stiles of FIG. 2A, and are particularly useful for pairs of doors that meet on the meeting stiles (the two stiles that face each other from separate doors when closed).

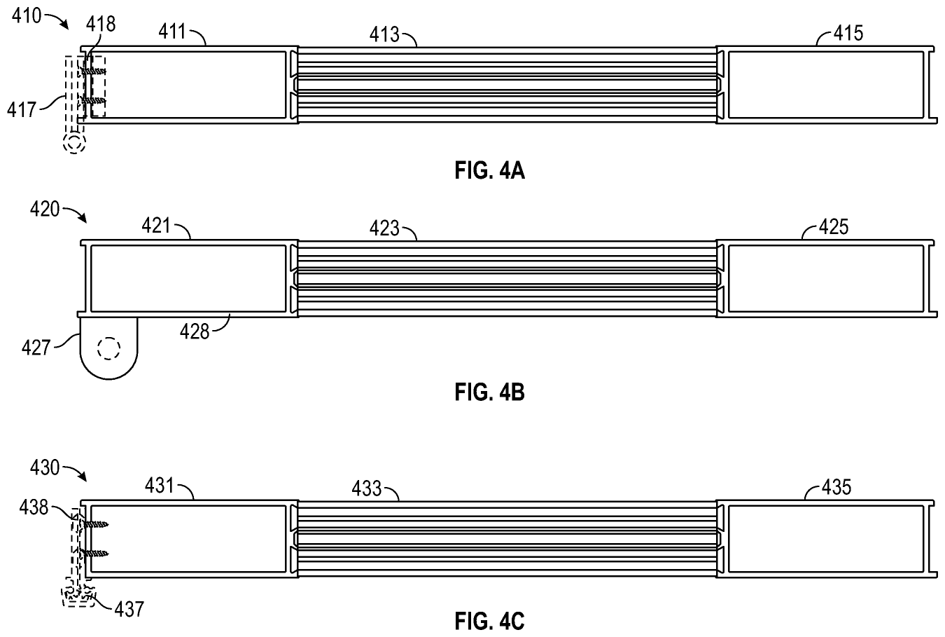

FIG. 3G illustrates one embodiment of a butt hinge back-up plate that can be used with the door chassis of FIG. 2A. In one embodiment, it is formed of extruded aluminum. Hinge back-up plate 361 may be required when using butt hinges to hang the door, such as that found in FIG. 4A.

FIG. 3H illustrates one embodiment of a screw-splined mid panel that can be used with the door chassis of FIG. 2A. Panel 371 can be coupled to stiles 203 to add one or more rails to chassis 201 between upper and lower rails 205. Panel 371 comprises a plurality of screw holes 373 that can be used to fasten the rail to the stile with a coupling plate, similar to that described in FIG. 2B.

FIGS. 4A-4C illustrate embodiments of a butt hinge, pivot hinge, and continuous hinge, respectively, that can be used with the door chassis of FIG. 2A. FIG. 4A illustrates door chassis 410 coupled to butt hinge 417. Door chassis 410 comprises hinge stile 411, latch stile 415, and rail 413. Butt hinge 417 is coupled to an exterior end face 418 of hinge stile 411. FIG. 4B illustrates door chassis 420 coupled to pivot hinge 427. Door chassis 420 comprises hinge stile 421, latch stile 425, and rail 423. Pivot hinge 427 is coupled to an exterior side face 428 of hinge stile 421. FIG. 4C illustrates door chassis 430 coupled to continuous hinge 437. Door chassis 430 comprises hinge stile 431, latch stile 435, and rail 433. Continuous hinge 427 is coupled to an exterior end face 438 of hinge stile 431. In one embodiment, a portion of the end face of stile 431 is removed to allow for coupling of the continuous hinge

The disclosed joint offers many different benefits. Because it is not welded, it is fully installable, customizable, and serviceable in the field. Each part of the door chassis can be disassembled, serviced, repaired, and/or replaced without having to remove the entire door to break welds that hold the door together. The disclosed joint design allows for better inventory control as well. This is achieved by the use of only one stile profile for each door size offered. For example, a single door size may be combined with any number of astragal covers (element 213) or exterior molds to achieve the required stile profile end face. In one embodiment, the astragal may be beveled for a hinged chassis, and in other embodiments may be singled or radiused, and may or may not include a seal. These astragal covers take up much less space and are less expensive to purchase and stock. Because the astragal covers can be added replaced or changed at any time, they allow the door to be fabricated and assembled regardless of the stock on hand, further maximizing production efficiency. In contrast, the prior art door chassis use different profiles (shapes) based on the door itself, and how the door is hinged and configured. Existing door chassis require a large amount of stock length material for each of different shapes and colors for each size, resulting in inefficient use of warehouse space, additional cost of inventory.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention.

Many other variations in the system are within the scope of the invention. For example, the door chassis system may or may not be formed of aluminum, astragal covers may or may not be used, and other fasteners besides screw splines can be utilized consistent with the disclosed design. A securing rod may or may not be used in addition to the screw fasteners to create a solid joint. The door chassis may be coupled to a door frame by any number of techniques, such as a butt hinge, a pivot hinge, and a continuous hinge. It is emphasized that the foregoing embodiments are only examples of the very many different structural and material configurations that are possible within the scope of the present invention.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A door chassis system, comprising:
a plurality of rails; and
a plurality of stiles,
wherein the plurality of stiles is coupled to the plurality of rails by a plurality of screws.

2. The door chassis system of claim 1, wherein each of the plurality of stiles comprises an exterior face with a groove configured to receive a removable astragal.

3. The door chassis system of claim 1, wherein an exterior face of each of the plurality of stiles comprises an opening configured to receive the plurality of screws.

4. The door chassis of system of claim 1, further comprising an astragal coupled to an outer edge of each of the plurality of stiles.

5. The door chassis system of claim 1, further comprising a coupling plate configured to attach each of the plurality of rails to each of the plurality of stiles.

6. The door chassis system of claim 5, wherein the coupling plate is configured to be inserted into an inner portion of the stile and receive the plurality of screws.

7. A door chassis joint apparatus, comprising:
a rail;
a stile;
a coupling plate; and
a plurality of screws that couple the rail to the stile, wherein the coupling plate is located in an interior portion of the stile, wherein the plurality of screws couple the coupling plate to the stile.

8. The door chassis of claim 7, further comprising a groove in an exterior face of the stile configured to receive a removable astragal.
